(19) United States
(12) Patent Application Publication
(10) Pub. No.: US 2016/0105340 A1
(43) Pub. Date: Apr. 14, 2016

(54) REPEATER

(71) Applicant: Hitachi Metals, Ltd., Tokyo (JP)

(72) Inventors: Yohei SHIRAKAWA, Hitachi (JP); Koki Hirano, Hitachinaka (JP); Kanako Suzuki, Hitachi (JP); Takumi Kobayashi, Hitachi (JP); Yoshitake Ageishi, Hitachi (JP)

(21) Appl. No.: 14/873,087

(22) Filed: Oct. 1, 2015

(30) Foreign Application Priority Data
Oct. 8, 2014 (JP) 2014-207270

(51) Int. Cl. H04L 12/26; G08B 5/36

(52) U.S. Cl. CPC H04L 43/0811; G08B 5/36

(57) ABSTRACT

A repeater includes a plurality of input-side connectors and a plurality of output-side connectors corresponding to the input-side connectors that are configured such that communication cables connected to the input-side connectors are connected to other communication cables connected to the output-side connectors, and a detection indicating circuit provided between the input-side connectors and the corresponding output-side connectors. The detection indicating circuit includes a detection circuit branching, extracting and outputting a portion of signal transmitted between the input-side connectors and the corresponding output-side connectors, and an indicating circuit for indicating an establishment of information communication according to an output from the detection circuit.

The present application is based on Japanese patent application No. 2014-207270 filed on Oct. 8, 2014, the entire contents of which are incorporated herein by reference.

### BACKGROUND OF THE INVENTION

1. Field of the Invention

The invention relates to a repeater.

2. Description of the Related Art

In large-scale facilities such as a data center, repeaters are provided between information and communication devices such as a server and a hub to organize inputs and outputs to easily identify intended purpose and also to easily change connection destination etc.

The repeaters are each provided with plural input-side connectors and plural output-side connectors corresponding thereto, and are configured such that communication cables (e.g., LAN (local area network) cables) connected to the input-side connectors and other communication cables connected to the corresponding output-side connectors are connected therebetween.

In the data center etc., the connection of a communication cable may be changed in accordance with layout change, displacement or addition of information and communication device.

Some information and communication devices are provided with a connection check lamp for checking the connection of communication cable so as to determine whether the communication cable is connected.

Also, a device has been proposed in which the connection of the communication cable is monitored by detecting the insertion and removal of the connector of the communication cable (see e.g., JP-B-5274671).

### SUMMARY OF THE INVENTION

The conventional devices can only check the physical connection of the communication cable. Thus, it is not possible to check whether the communication is actually established through the communication cable.

The communication cable may be erroneously removed without noticing the establishment of communication. Thus, a failure may be caused which includes a service shutdown of the information communication device and a data corruption during transfer.

Where the connection of the communication cable is monitored as in JP-B-5274671, the communication cable needs a built-in monitoring signal line. Since a versatile communication cable is thus difficult to use therewith, the manufacturing cost may increase.

It is an object of the invention to provide a repeater that allows the notification of the establishment of information communication therethrough so as to prevent the erroneous removal of the communication cable even if versatile communication cables are used.

(1) According to one embodiment of the invention, a repeater comprises:

a plurality of input-side connectors and a plurality of output-side connectors corresponding to the input-side connectors that are configured such that communication cables connected to the input-side connectors are connected to other communication cables connected to the output-side connectors; and

a detection indicating circuit provided between the input-side connectors and the corresponding output-side connectors,

wherein the detection indicating circuit comprises a detection circuit branching, extracting and outputting a portion of signal transmitted between the input-side connectors and the corresponding output-side connectors, and an indicating circuit for indicating an establishment of information communication according to an output from the detection circuit.

In the above embodiment (1) of the invention, the following modifications and changes can be made.

(i) The repeater further comprises:

a plurality of repeater modules each comprising at least one set comprising one of the input-side connectors, one of the output-side connectors and the detection indicating circuit; and

a front panel,

wherein the plurality of repeater modules are attached to the front panel.

(ii) The repeater modules comprise:

a power port for receiving externally supplied power; and

an inter-module power input/output port for receiving power from another repeater module or for outputting power, received through the power port or received from the other repeater module, to still another repeater module.

(iii) The repeater modules are attachable to the front panel even when being vertically inverted.

(iv) The repeater further comprises a housing,

wherein the input-side connectors are arranged on a front side of the housing,

wherein the output-side connectors are arranged on a back side of the housing, and

wherein the indicating circuit has a light-emitting portion that is provided on the front and back sides of the housing corresponding to the input-side and output-side connectors and indicate the establishment of information communication by light emission.

(v) The input-side connectors are fitted into a front-side insertion hole formed on the front side of the housing so as to be supported by the housing, and

wherein the input-side connectors are fitted into a back-side insertion hole formed on the back side of the housing so as to be supported by the housing.

(vi) The detection circuit comprises a rectifier circuit and a comparator, the rectifier circuit branching and extracting a portion of signal transmitted between the input-side connectors and the output-side connectors, rectifying the extracted signal into a DC signal and outputting the DC signal, and the comparator outputting a signal with a predetermined voltage when output voltage of the rectifier circuit is not less than a preset threshold voltage, and

wherein the indicating circuit comprises a light-emitting circuit that emits light when the comparator outputs the signal with a predetermined voltage.

(vii) The detection circuit further comprises a matching circuit for adjusting a level of the signal extracted from between the input-side connectors and the output-side connectors.

(viii) The detection circuit further comprises an amplifier circuit that amplifies the signal extracted from between the input-side connectors and the output-side connectors and outputs the amplified signal to the matching circuit.

### EFFECTS OF THE INVENTION

According to an embodiment of the invention, a repeater can be provided that allows the notification of the establishment of information communication therethrough so as to prevent the erroneous removal of the communication cable even if versatile communication cables are used.

### BRIEF DESCRIPTION OF THE DRAWINGS

Next, the present invention will be explained in more detail in conjunction with appended drawings, wherein:

FIG. 1A is an illustration diagram showing a transmission system with a repeater in an embodiment of the invention;

FIG. 1B is an illustration diagram showing an internal configuration of the repeater;

FIG. 2 is an illustration diagram showing a detection indicating circuit used in the repeater of FIGS. 1A and 1B;

FIG. 3A is a perspective view showing the repeater in FIGS. 1A and 1B;

FIG. 3B is an exploded perspective view showing the repeater in FIGS. 1A and 1B;

FIG. 4A is a perspective view showing a repeater module of the repeater in FIGS. 3A and 3B;

FIG. 4B is an exploded perspective view showing the repeater module of the repeater in FIGS. 3A and 3B;

FIG. 5 is an illustration diagram showing an example of how to use the repeater in the embodiment; and

FIGS. 6A and 6B are a front view showing modifications of the repeater module used for the repeater in the embodiment.

### DETAILED DESCRIPTION OF THE PREFERRED EMBODIMENTS

An embodiment of the invention will be described below in conjunction with the appended drawings.

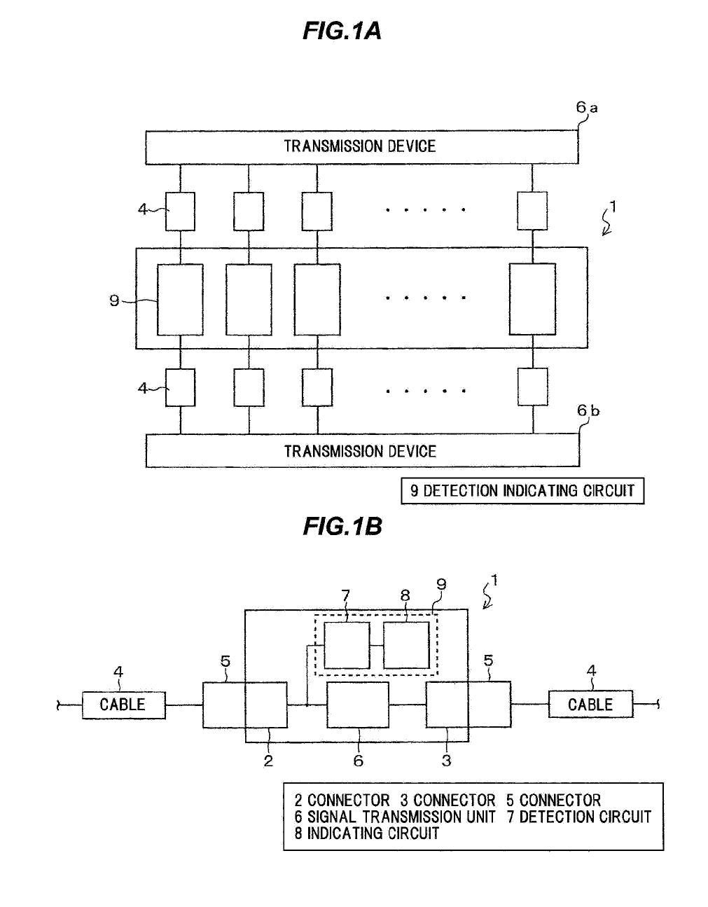

FIG. 1A is an illustration diagram showing a transmission system with the repeater in the embodiment and FIG. 1B is an illustration diagram showing an internal configuration of the repeater.

As shown in FIGS. 1A and 1B, a repeater 1 is provided with plural input-side connectors 2 and plural output-side connectors 3 corresponding to the input-side connectors 2, and is used for connection between communication cables 4 connected to the input-side connectors 2 and other communication cables 4 connected to the corresponding output-side connectors 3.

In the present specification, connectors on one side are referred to as input-side connectors 2 and those on the other side as output-side connectors 3 for convenience. However, “input” and “output” do not define signal transmission directions and signals can be bi-directionally transmitted between the input-side connector 2 and the output-side connector 3.

The input-side connector 2 and the output-side connector 3 are, e.g., jack connectors conforming to the RJ45 standard and are connectable to a connector 5 (e.g., a plug connector conforming to the RJ45 standard) provided at an end of the communication cable 4.

When the communication cable 4 extending from a transmission device 6a on one side is connected to the input-side connector 2 of the repeater 1 and the communication cable 4 extending from a transmission device 6b on the other side is connected to the corresponding output-side connector 3, the two transmission devices 6a and 6b are communicatively connected through the repeater 1. The transmission devices 6a and 6b are e.g., an information and communication device such as a server or a hub.

As the communication cable 4, it is possible to use a universal LAN (Local Area Network) cable. The communication cable 4 having four pairs of signal lines (eight in total) for transmitting differential signals is used in the present embodiment.

A signal transmission unit 6 is disposed between the input-side connector 2 and the output-side connector 3 for transmitting signals therebetween. The signal transmission unit 6 may be provided with an impedance control circuit, etc., to prevent degradation of signals transmitted between the two connectors 2 and 3.

The repeater 1 in the present embodiment has detection indicating circuits 9 each provided between the input-side connector 2 and the corresponding output-side connector 3 and each having a detection circuit 7 branching, extracting and outputting a portion of signal transmitted between the two connectors 2 and 3 and an indicating circuit 8 for indicating a telecommunication state based on the output from the detection circuit 7. The detection indicating circuits 9 are provided respectively between the input-side connectors 2 and the corresponding output-side connectors 3 to indicate the telecommunication state of each port.

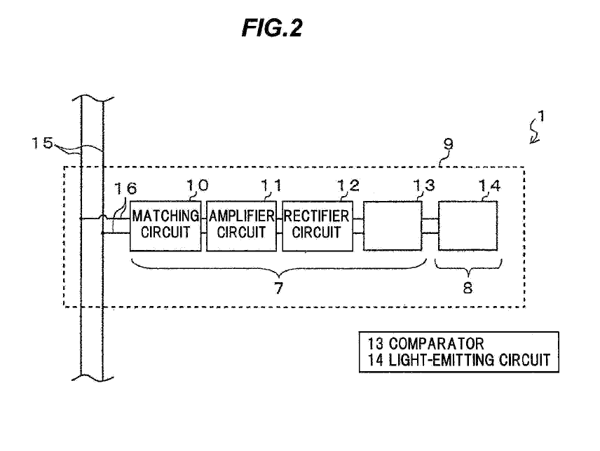

As shown in FIG. 2, the detection circuit 7 is composed of a matching circuit 10, an amplifier circuit 11, a rectifier circuit 12 and a comparator 13 which are connected sequentially. Meanwhile, in the present embodiment, a light-emitting circuit 14 which indicates the telecommunication state by emitting light is used as the indicating circuit 8.

The matching circuit 10 is to provide impedance matching in a predetermined frequency band. In the present embodiment, since a portion of signal transmitted between the two connectors 2 and 3 is branched and extracted, the matching circuit 10 also serves to adjust the level of a signal extracted from between the two connectors 2 and 3.

In the present embodiment, four differential signals are transmitted between the two connectors 2 and 3 and four transmission paths are thus formed. Then, branch transmission paths 16 branched from a given pair of transmission lines 15 enter the matching circuit 10. The matching circuit 10 is configured to appropriately include, e.g., a resistive circuit and LC filter, etc.

The amplifier circuit 11 is a circuit which amplifies the signal extracted from a given transmission line 15 through the matching circuit 10 and outputs the amplified signal to the downstream rectifier circuit 12. As the amplifier circuit 11, it is possible to use, e.g., a grounded emitter circuit. However, the specific configuration of the amplifier circuit 11 is not limited thereto. Although the amplifier circuit 11 is a single-stage configuration in the present embodiment, the amplifier circuit 11 may be a multistage configuration.

The rectifier circuit 12 rectifies the AC signal amplified by the amplifier circuit 11 into a DC signal and outputs the DC signal to the downstream comparator 13. As the rectifier circuit 12, it is possible to use a well-known full-wave rectifier circuit or half-wave rectifier circuit.

The light-emitting circuit 14 used as the indicating circuit 8 is configured to emit light when the output of the comparator 13 is ON, i.e., when the comparator 13 is outputting a signal with a predetermined voltage.

In the present embodiment, the light-emitting circuit 14 is configured to emit light from one of light-emitting diodes of different colors depending on presence or absence of the output of the comparator 13. The light-emitting circuit 14 can be configured such that, e.g., a blue or green light-emitting diode emits light when the output of the comparator 13 is ON (information transmission is being performed) and a red light-emitting diode emits light when the output of the comparator 13 is OFF (information transmission is not performed). Since the light-emitting circuit 14 is configured to emit light also when information transmission is not performed, it is possible to check presence/absence of power supply by light emission.

The repeater 1 in the present embodiment has the comparator 13 between the rectifier circuit 12 and the light-emitting circuit 14.

The comparator 13 is a circuit which is turned on and outputs a DC signal with a predetermined voltage to the downstream light-emitting circuit 14 when the output voltage of the rectifier circuit 12 is not less than a preset threshold voltage (offset voltage).

Providing the comparator 13 allows a signal with a constant voltage to be output to the light-emitting circuit 14 even when the output voltage of the rectifier circuit 12 is small as long as offset voltage of the comparator 13 is set to a low level, and it is thereby possible to stably operate the light-emitting circuit 14.

Therefore, it is possible to reduce the level of the signal to be extracted by increasing the resistance value of the matching circuit 10, which reduces reflection loss and insertion loss and thus suppresses deterioration in quality of the signal.

Meanwhile, strength of the signal transmitted through the communication cable 4 may be different depending on the transmission device 6a or 6b connected to the communication cable 4 or length of the communication cable 4. However, since the comparator 13 is provided, it is possible to stably operate the light-emitting circuit 14 even when the strength of the signal transmitted through the communication cable 4 is small.

Furthermore, since the output voltage of the rectifier circuit 12 can be reduced, it is possible to reduce output voltage of the amplifier circuit 11, to lower power consumption, and even to suppress deterioration in signal quality caused because the output signal of the amplifier circuit 11 enters the communication cable 4.

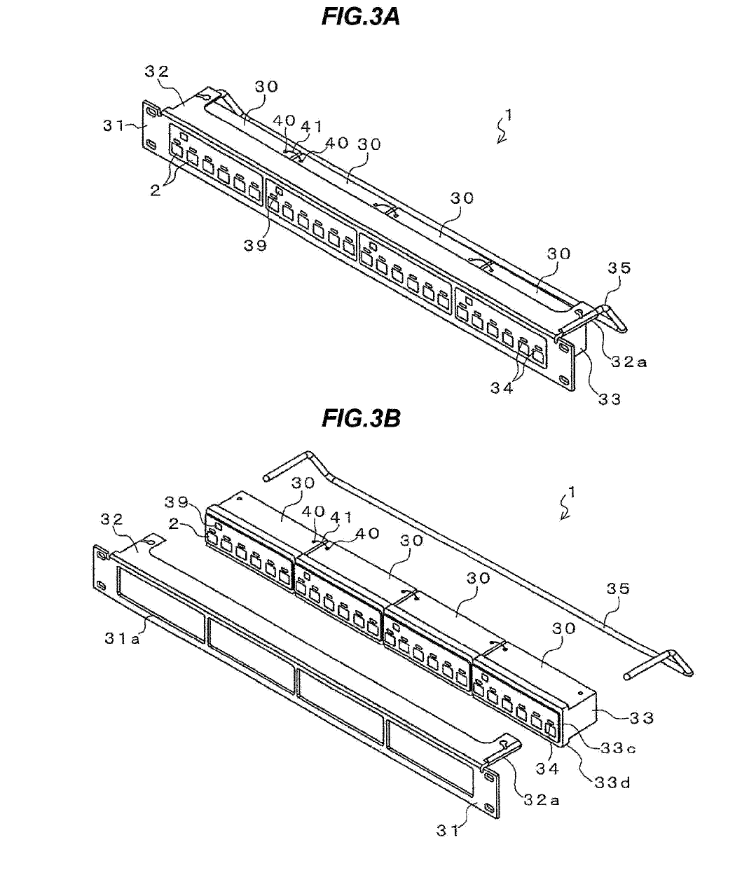

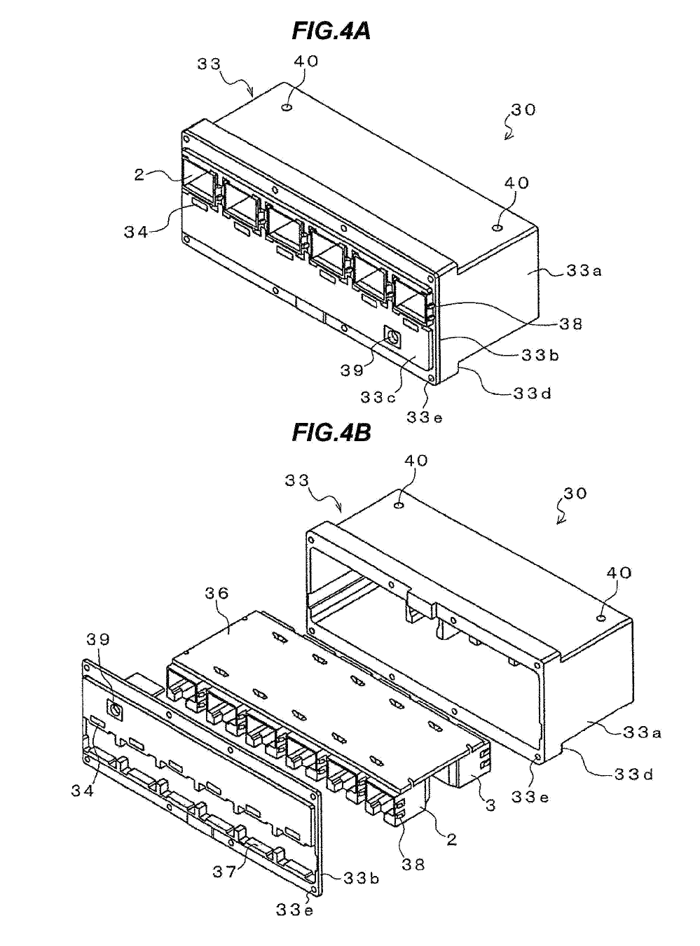

As shown in FIGS. 3A to 4B, the repeater 1 in the present embodiment has a divided structure composed of plural repeater modules 30 each having at least one set of the input-side connector 2, the output-side connector 3 and the detection indicating circuit 9, and is formed by attaching the plural repeater modules 30 to a front panel 31.

In the present embodiment, four 6-port repeater modules 30 each having six sets of the input-side connector 2, the output-side connector 3 and the detection indicating circuit 9 are combined to realize the repeater 1 having twenty-four ports in total. The number of the ports of the repeater module 30 and the number of the repeater modules 30 (i.e., the number of divisions) are not limited thereto.

Since the repeater 1 is composed of plural divided repeater modules 30, it is possible to suitably increase or reduce the repeater modules 30 depending on the number of ports to be used and thus possible to introduce systems at low cost. In addition, using a different repeater module 30 for every intended purpose allows misconnection to be prevented.

Hereinafter, a vertical direction in FIGS. 3A to 4B is referred to as a height direction, a direction from left front toward right back is referred to as a depth direction, and a direction from right front toward left back is referred to as a width direction.

The front panel 31 is formed to have height and width which correspond to a rack to which the front panel 31 is attached. In the present embodiment, the front panel 31 is 1 U in size defined by IEC 60917 (JIS C 6010).

In the present embodiment, the repeater 1 is divided only in the width direction since the size of the front panel 31 is 1 U. However, when the size of the front panel 31 is 2 U or larger, the repeater 1 may be divided also in the height direction. In this case, the repeater modules 30 are arranged in the width direction as well as in the height direction.

A top plate 32 is integrally provided on the front panel 31 so as to protrude backward from the upper portion of the front panel 31, and a cable holder 35 is attached to the top plate 32.

The cable holder 35 is to support, from below, the communication cables 4 extending on the back side (and connected to the output-side connectors 3) to reduce a load on connecting portions of the communication cables 4. The cable holder 35 is formed by bending a metal rod and is held by holding portions 32a formed at both widthwise ends of the top plate 32. The shape of the cable holder 35 is not limited to that shown in the drawings.

Although the cable holder 35 is provided only on the back side in the embodiment, a member corresponding to the cable holder may be separately provided also on the front side. In this case, for example, a cable holding unit may be provided in a space under the rack to which the front panel 31 is attached, so that the communication cables 4 extending on the front side are supported by the unit.

The repeater module 30 is provided with a housing 33 having a substantially rectangular parallelepiped shape. The input-side connectors 2 are arranged on the front side of the housing 33 and the output-side connectors 3 are arranged on the back side of the housing 33. The input-side connectors 2 and the output-side connectors 3 are respectively arranged in a row along the width direction.

The input-side connectors 2 and the output-side connectors 3 are arranged below the center of the housing 33 in the height direction, and light-emitting portions 34 to indicate the telecommunication state by light emission therethrough are formed respectively above the center so as to correspond to the connectors 2 and 3. The light-emitting portions 34 are windows to visually check light emission of the light-emitting diodes of the light-emitting circuit 14 and are formed by providing a transparent resin in through-holes formed on the housing 33.

In the present embodiment, the light-emitting portions 34 are formed on two sides, the front and back sides, of the housing 33. Therefore, each light-emitting circuit 14 is configured so that the light-emitting diodes are arranged on two sides so as to respectively correspond to the two light-emitting portions 34.

The housing 33 of the repeater module 30 is composed of a cylindrical main body 33a with a back-side opening closed and a lid portion 33b provided to cover a front-side opening of the main body 33a, and is configured that the input-side connectors 2, the output-side connectors 3 and a circuit board 36 mounting the both connectors 2 and 3 are housed in an internal space of the main body 33a. The detection indicating circuits 9 and the signal transmission units 6 are mounted on the circuit board 36.

The both connectors 2 and 3 are provided on the circuit board 36 so that front end portions on the cable insertion side protrude from edges of the circuit board 36. A front-side connector insertion hole 37 for housing the front end portions of the input-side connectors 2 is formed on the front side of the housing 33, e.g., on the lid portion 33b. Then, a back-side connector insertion hole, although not shown, for housing the front end portions of the output-side connectors 3 is formed on the back side of the housing 33, e.g., on the back side of the main body 33a.

In the repeater module 30, the input-side connectors 2 are supported on the housing 33 by fitting the front end portions thereof into the front-side connector insertion hole 37, and the output-side connectors 3 are supported on the housing 33 by fitting the front end portions thereof into the back-side connector insertion hole.

In the present embodiment, locking claws 38 are formed on side surfaces of the both connectors 2 and 3 and are locked to the edge of the housing 33 when the both connectors 2 and 3 are inserted into the front-side connector insertion hole 37 and the back-side connector insertion hole, thereby fixing the both connectors 2 and 3 to the housing 33. The circuit board 36 is fixed to the housing 33 via the both connectors 2 and 3.

In other words, in the present embodiment, supporting the both connectors 2 and 3 by the housing 33 provides positioning of the circuit board 36 relative to the housing 33 (including positioning of the light-emitting diodes of the light-emitting circuits 14 relative to the light-emitting portions 34). Such a configuration allows the repeater module 30 to be downsized as compared to the case of separately providing a member for fixing or positioning the connectors 2 and 3, and also the cost is reduced by simplifying the structure.

In addition, in the repeater module 30, a power port 39 for receiving externally supplied power is provided on the front side of the housing 33 and power is externally supplied by connecting a power cable (not shown) to the power port 39. The power received through the power port 39 is supplied to the amplifier circuits 11, the comparators 13 and the light-emitting circuits 14.

Although DC power is supplied to the power port 39 in the present embodiment, AC power may be supplied to the power port 39 when the repeater module 30 is provided with a power circuit for converting the supplied AC power into DC power with a predetermined voltage.

A power source connected to the power port 39 may be a battery. Using a battery allows the repeater 1 (the detection indicating circuit 9) to operate even in the place with no external power source.

When power is not supplied to the repeater 1, the detection indicating circuit 9 does not operate. However, since the signal transmission unit 6 does not need power supply, the repeater 1 performs a general function as a repeater, which is connection between the communication cables 4 connected to the connectors 2 and those connected to the connectors 3. Therefore, when using the repeater 1, power can be supplied only when the telecommunication state is needed to be checked.

The repeater module 30 is also provided with inter-module power input/output ports 40 for receiving power from another repeater module 30 or for outputting power, received through the power port 39 or received from another repeater module 30, to still another repeater module 30, so that power can be shared between plural repeater modules 30.

As a result, as long as the inter-module power input/output ports 40 of the plural repeater modules 30 are connected to each other through power sharing cables 41, power is supplied to all of the repeater modules 30 by externally supplying power to one of the plural repeater modules 30.

In the present embodiment, since the repeater modules 30 are configured to be arranged in the width direction, the inter-module power input/output ports 40 are formed on the upper surface of the housing 33 at both ends in the width direction to facilitate power supply to adjacent repeater modules 30 and also to facilitate connection of the cables 41. The positions of the inter-module power input/output ports 40 are not limited thereto and the inter-module power input/output ports 40 may be provided, e.g., on the side surfaces or the bottom surface of the repeater module 30.

In addition, in the present embodiment, the repeater module 30 can be attached upside down to the front panel 31.

In detail, through-holes 31a having a vertically symmetrical shape (a substantially rectangular shape in the embodiment) are provided on the front panel 31 at the center of the height direction, a raised portion 33c having the same shape as the through-hole 31a is provided on the front surface (the lid portion 33b) of the housing 33 of each repeater module 30 at the center in the height direction, and each repeater modules 30 is fixed to the front panel 31 by housing the raised portion 33c in the through-hole 31a.

A flange portion 33d protruding on upper and lower sides in the height direction is formed at an end portion of the housing 33 of the repeater module 30 on the front side. On the flange portion 33d, plural screw holes 33e are formed at symmetric positions about the center, in the height and width directions, of the front surface of the housing 33. Screw holes, although not shown, are formed on the front panel 31 at positions facing the screw holes 33e when the raised portion 33c is housed in the through-hole 31a, and the repeater module 30 is fixed to the front panel 31 by screws inserted through the both screw holes.

Port numbers, although not shown in FIGS. 3A and 3B, are marked on the front panel 31 below the through-holes 31a so as to respectively correspond to the input-side connectors 2 when the repeater module 30 is fixed to the front panel 31, and also memo sections for writing intended purpose, etc., are provided above the through-holes 31a so as to respectively correspond to the input-side connectors 2.

Since the repeater module 30 can be arranged upside down, it is possible to appropriately select whether the light-emitting portions 34 are positioned above or below the input-side connectors 2, depending on wiring layout, etc., of the communication cables 4.

When, for example, two repeaters 1 are used as shown in FIG. 5, three units of a rack 51 (3 U space) may be used such that a repeater 1 having the repeater modules 30 with the light-emitting portions 34 located above the input-side connectors 2 is provided in the upper unit, another repeater 1 having the repeater modules 30 with the light-emitting portions 34 located below the input-side connectors 2 is provided in the lower unit, and the communication cables 4 connected to the input-side connectors 2 of the two repeaters 1 are routed through the middle unit to the back side of the rack 51. In this case, the occupied space in the rack 51 is reduced, the light-emitting portions 34 of the both repeaters 1 are not hidden behind the communication cables 4, and it is easy to check the telecommunication state of each port.

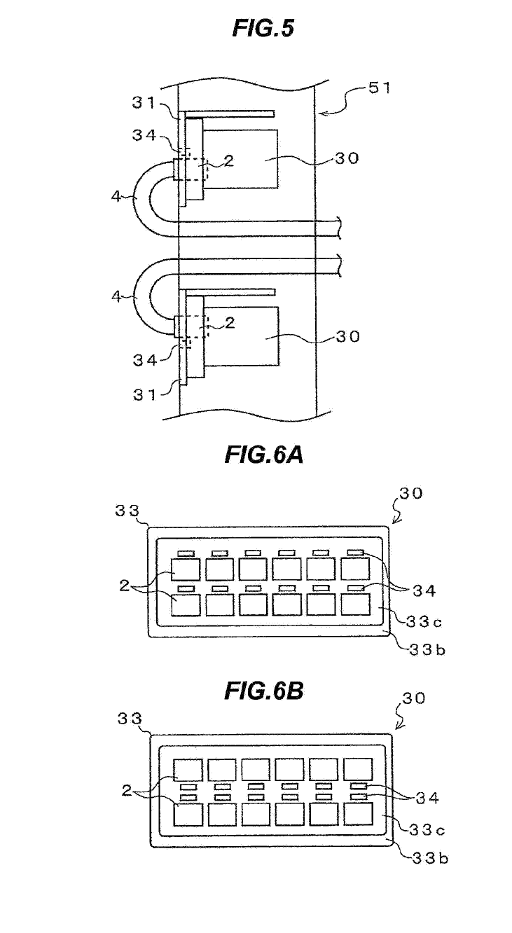

In addition, although the input-side connectors 2 and the output-side connectors 3 are respectively arranged in a row in the present embodiment, the input-side connectors 2 and the output-side connectors 3 may be arranged in two rows as shown in FIGS. 6A and 6B to increase the number of ports. In this case, the light-emitting portions 34 may be provided on the same side (on the upper side in the drawing) of each of the rows of the connectors 2 and 3 as shown in FIG. 6A, or the light-emitting portions 34 may be provided on different sides (on the center side in the drawing) of the rows of the connectors 2 and 3 as shown in FIG. 6B.

When the size of the repeater 1 (the repeater module 30) is 1 U, it is difficult to arrange the input-side connectors 2 and the output-side connectors 3 in two rows due to the limited space. However, when the size of the repeater 1 (the repeater module 30) is 2 U or more, the input-side connectors 2 and the output-side connectors 3 may be arranged in two or more rows.

As described above, the repeater 1 in the present embodiment is provided with the detection indicating circuits 9 each provided between the input-side connector 2 and the corresponding output-side connector 3 and each having the detection circuit 7 branching, extracting and outputting a portion of signal transmitted between the two connectors 2 and 3 and the indicating circuit 8 for indicating the telecommunication state based on the output from the detection circuit 7.

Such a configuration allows the telecommunication state to be indicated per port and it is thereby possible to prevent removal of the communication cable 4 by mistake.

In addition, in the present embodiment, it is possible to use a universal communication cable as the communication cable 4 and the cost is therefore low since it is not necessary to provide a monitoring signal line, etc., in the communication cable 4, unlike the conventional technique.

The present invention is not intended to be limited to the embodiment, and it is obvious that the various kinds of changes can be made without departing from the gist of the invention.

For example, although the indicating circuit 8 is constructed from the light-emitting circuit 14 in the embodiment, it is not limited thereto. The indicating circuit 8 may be, e.g., configured to include a monitor such as a display so that the telecommunication state of each port is shown on the display.

In addition, when using plural repeater modules 30, the color of each repeater module 30 (e.g., the color of the housing 33) may be different, although it is not mentioned in the embodiment. This makes easy to distinguish the repeater modules 30 and it is thus possible to further prevent troubles such as misconnection.

What is claimed is:

1. A repeater, comprising:
a plurality of input-side connectors and a plurality of output-side connectors corresponding to the input-side connectors that are configured such that communication cables connected to the input-side connectors are connected to other communication cables connected to the output-side connectors; and
a detection indicating circuit provided between the input-side connectors and the corresponding output-side connectors,
wherein the detection indicating circuit comprises a detection circuit branching, extracting and outputting a portion of signal transmitted between the input-side connectors and the corresponding output-side connectors, and an indicating circuit for indicating an establishment of information communication according to an output from the detection circuit.

2. The repeater according to claim 1, further comprising:
a plurality of repeater modules each comprising at least one set comprising one of the input-side connectors, one of the output-side connectors and the detection indicating circuit; and
a front panel,
wherein the plurality of repeater modules are attached to the front panel.

3. The repeater according to claim 2, wherein
the repeater modules comprise:
a power port for receiving externally supplied power; and
an inter-module power input/output port for receiving power from another repeater module or for outputting power, received through the power port or received from the other repeater module, to still another repeater module.

4. The repeater according to claim 2, wherein the repeater modules are attachable to the front panel even when being vertically inverted.

5. The repeater according to claim 1, further comprising a housing,
wherein the input-side connectors are arranged on a front side of the housing,
wherein the output-side connectors are arranged on a back side of the housing, and
wherein the indicating circuit has a light-emitting portion that is provided on the front and back sides of the housing corresponding to the input-side and output-side connectors and indicate the establishment of information communication by light emission.

6. The repeater according to claim 5, wherein the input-side connectors are fitted into a front-side insertion hole formed on the front side of the housing so as to be supported by the housing, and
wherein the input-side connectors are fitted into a back-side insertion hole formed on the back side of the housing so as to be supported by the housing.

7. The repeater according to claim 1, wherein the detection circuit comprises a rectifier circuit and a comparator, the rectifier circuit branching and extracting a portion of signal transmitted between the input-side connectors and the output-side connectors, rectifying the extracted signal into a DC signal and outputting the DC signal, and the comparator outputting a signal with a predetermined voltage when output voltage of the rectifier circuit is not less than a preset threshold voltage, and
wherein the indicating circuit comprises a light-emitting circuit that emits light when the comparator outputs the signal with a predetermined voltage.

8. The repeater according to claim 7, wherein the detection circuit further comprises a matching circuit for adjusting a level of the signal extracted from between the input-side connectors and the output-side connectors.

9. The repeater according to claim 7, wherein the detection circuit further comprises an amplifier circuit that amplifies the signal extracted from between the input-side connectors and the output-side connectors and outputs the amplified signal to the matching circuit.
